(19) United States
(12) Patent Application Publication
(10) Pub. No.: US 2015/0223476 A1
(43) Pub. Date: Aug. 13, 2015

(54) METHOD FOR PRODUCING FOOD USING PRICKLY PEAR CACTUS FRUIT

(71) Applicant: Jiyoon Moon, (US)

(72) Inventor: Jiyoon Moon, Busan (KR)

(21) Appl. No.: 14/367,819

(22) PCT Filed: Dec. 5, 2012
(86) PCT No.: PCT/KR2012/010457

§ 371 Date: Jun. 20, 2014

(30) Foreign Application Priority Data
Dec. 20, 2011 (KR) 1020110138345

(51) Int. Cl. A21D 2/36

(52) U.S. Cl. CPC A21D 2/36

(57) ABSTRACT

A method for producing a food using an Opuntia Ficus-indica fruit includes an acid dough preparation step by using an ingredient including an Opuntia Ficus-indica fruit, a liquid starter preparation step by mixing flour with the acidic dough, a main dough preparation step by adding grain powder, flour, and salt to the liquid starter, a fermentation step, and a food producing step, wherein the acidic dough preparation step includes a mixing step, a stirring step, and an aging step. According to the method including above features, a food using Opuntia Ficus-indica fruit, which is particularly effective on diabetes mellitus and so forth, can be quickly and efficiently prepared.

### TECHNICAL FIELD

The present invention relates to a method for producing a food using an Opuntia Ficus-indica fruit, and more particularly to a method for producing a food using an Opuntia Ficus-indica fruit by appropriately treating an ingredient including Opuntia Ficus-indica fruit powder to effectively produce a food such as bread or snack foods.

### BACKGROUND ART

Occurrence of diabetes mellitus has been rapidly increased, due to environmental factors such as stress, lack of exercise, and high-calories, high-fat, and high-protein diet caused by westernization of diet. Diabetes mellitus is indicated as one of three main diseases along with cancers and circulatory system diseases.

Diabetes mellitus, which is occurred in the case where physiological activity of insulin is low or a. physiological function of insulin is insufficient, refers to a symptom in which saccharides are detected in urine. To treat diabetes mellitus, drug therapy, dietary therapy, or exercise therapy is generally used alone or in combination. Recently, there is increased interest in dietary therapy to treat diabetes mellitus through appropriate food intake. Therefore, a study about a food including an active ingredient for alleviating, diabetes mellitus among foods has been extensively conducted.

Among foods including an active ingredient for alleviating diabetes mellitus, it has been reported that an Opuntia Ficus-indica fruit has a large amount of an active ingredient for alleviating diabetes mellitus. Thus, a development of a food using an Opuntia Ficus-indica fruit has been extensively made.

Among cacti cultivated or naturally grown in Jeju island, powder of an Opuntia Ficus-indica fruit, which is a herbaceous perennial plant derived from a tropical area and belonging to genus Opuntia, has a composition of 9.3 wt % of water, 4.24 wt % of crude proteins, 1.35 wt % of crude lipids, 12.12 wt % of crude ash, 3.79 wt % of crude fibers, and 69.2 wt % of soluble nitrogen-free substances such as saccharides when the fruit is freeze-dried and pulverized. Particularly, since a dietary fiber, which is contained in an Opuntia Ficus-indica Fruit in a large amount, forms gel having high viscosity due to the increase in capacity to retain water, it is difficult to produce a food by using an Opuntia Ficus-indica fruit due to the dramatically increased viscosity.

Consequently, a method of appropriately adjusting viscosity should be devised to produce a food using an Opmitia Ficus-indica fruit, While conducting a study on “Antioxidative activity on Streptozotocin-induced diabetic mouse of and quality property of bread to which Opuntia Ficus-indica fruit is added” (see Mun, Gyeongok, Ph.D. dissertation, Kyungsung University, February 2011), the present inventor found that viscosity of dough may be dramatically reduced when a certain amount of oligosaccharide and water are compounded with Opuntia Ficus-indica fruit powder and then the resultant mixture is aged in an incubator at about 25° C. for about 12 hours. In addition, the present inventor also found that a food effective on preventing and treating diabetes mellitus can be produced by producing a food with dough including the aged Opuntia Ficus-indica fruit powder through a straight dough method.

However, there is a need to develop an improved and effective method for producing a food using an Opuntia Ficus-indica fruit due to the following: the method for producing a food using an Opuntia Ficus-indica fruit as above requires at least 12 hours to adjust viscosity of dough; the quality and texture of a produced food are not good due to the unevenness of stability and distribution of bubbles in dough because the food is prepared by a straight dough method; and the above method is not suitable for mass production of a food thereby having limitation in practical application.

### DISCLOSURE

### Technical Problem

The present invention is derived to satisfy the requirement as above. An object of the present invention is to provide a method for producing a food including Opuntia Ficus-indica fruit powder, wherein the method can adjust viscosity of dough including Opuntia Ficus-indica fruit powder within a short period of time make dough have homogeneous stability and distribution of bubbles; and be suitable for mass production.

### Technical Solution

An object of the present invention is achieved by completing a method for producing a food using an Opuntia Ficus-indica fruit, the method including: an acid dough preparation step of preparing acidic dough by using an ingredient comprising, an Opuntia Ficus-indica fruit; a liquid starter preparation step of preparing liquid starter by mixing flour with the acidic. dough prepared in the acidic. dough preparation step; a main dough preparation step of preparing main dough by adding grain powder, flour, and salt to the liquid starter prepared in the liquid dough preparation step; a fermentation step of introducing the main dough prepared in the main dough preparation step in a fermentor to ferment; and a food producing step of producing a food by using the main dough fermented by the fermentation step,
wherein the acidic dough preparation step includes: a mixing step of mixing ingredients; a stiffing step of introducing the mixture prepared by the mixing step in a stirrer to stir; and an aging step of introducing the acidic dough stirred in the stirring step in an incubator for a certain period of time for aging; and the ingredients mixed in the mixing step include saccharides and water.

It is preferable that the ingredients in the mixing step are mixed at a ratio of 1 to 5 wt % of Opuntia Ficus-indica fruit powder 5 wt % of saccharides, 35 wt % of water with respect to the weight of main dough.

Also, it is preferable that the stirring process in the stirring step is performed for 30 minutes in a constant-temperature water bath of which inside temperature is maintained at 90° C., and it is more preferable that the aging process of the aging step is performed for 3 hours in an incubator of which temperature is maintained at 60° C.

In addition, it is preferable that the process of preparing liquid starter in the liquid starter preparation step is performed by mixing the acidic dough with 10 wt % of flour with respect to the weight of main dough and then aging the resultant for 1 to 3 hours under a condition in which temperature of 28 to 30° C. and relative humidity of 75 to 80% are maintained and the fermentation process of the fermentation step is performed for 30 to 40 minutes in a fermenter in which temperature of 26 to 28° C. and relative humidity of 75 to 80% are maintained.

### Advantageous Effects

According to the present invention, viscosity of dough including Opuntia Ficus-indica fruit powder can be adjusted within a short period of time, and a food having homogeneous stability and distribution of bubbles in dough can be produced.

In addition, the present invention is advantageous for mass production of a food and has an effect of enhancing durability for fermentation, since the present invention produces an ingredient including Opuntia Ficus-indica fruit powder as liquid starter,

Further, according to the present invention, a food can be produced by using an ingredient including Opuntia Ficus-indica fruit powder which is particularly effective on diabetes mellitus, and thus diabetes mellitus can be alleviated and prevented by using the food.

### DESCRIPTION OF DRAWINGS

FIG. 1 is a flow chart showing a method for producing a food using an Opuntia Ficus-indica fruit according to the present invention,

FIG. 2 is a graph showing changes in viscosity of acid c dough including Opuntia Ficus-indica fruit powder produced by the conventional method,

FIG. 3 is a graph shoring changes in viscosity of acidic dough including Opuntia Ficus-indica fruit powder produced according to the present invention.

### BEST MODE

Hereinafter, the features of the present invention and the effect therefrom will be described in more details through accompanying drawings depicting preferred embodiments.

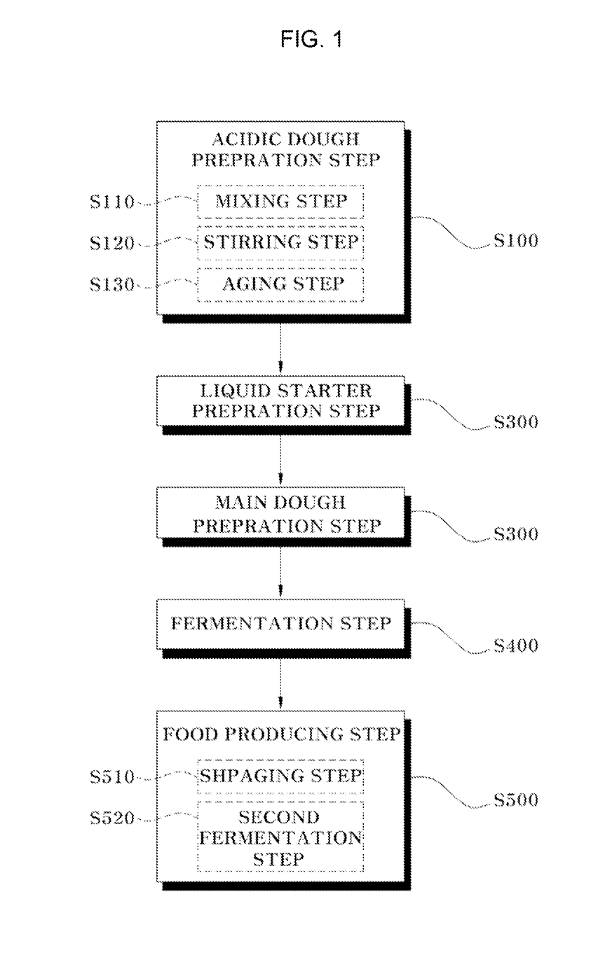

The present invention relates to a method for producing a food particularly effective on treating diabetes mellitus b using an Opuntia Ficus-indica fruit. To achieve this, as depicted in FIG. 1, the present invention includes an acidic dough preparation step (S100), a liquid starter preparation step (S200), a main dough preparation step (S300), a fermentation step (S400), and a food production step (S500), wherein the acidic dough mixing step (S100) has an ingredient mixing step (S110), a stirring step (S120), and an aging step (S130).

Hereinafter, each step as above is described in more details.

(1) Acidic Dough Preparation Step (S100)

To produce a food, firstly dough in an appropriately fermented state should be prepared by mixing ingredients. The present step is to prepare acidic dough (also referred to as “sour dough”. And hereinafter, it is designated as “acidic dough”) by using Opuntia Ficus-indica fruit powder before preparing liquid starter and main dough. The acidic dough preparation step (S100) of the present invention includes a mixing step (S110), a stifling step (S120), and an aging step (S130) as follows.

(a) Mixing Step (S110)

This is a step to produce acidic dough by mixing water and saccharides such as oligosaccharides or sucrose with an ingredient including Opuntia Ficus-indica fruit powder (OFP) in a stirrer, it is preferable that a mixing ratio of respective ingredients is 1 to 5 wt % of Opuntia Ficus-indica fruit powder, 5 wt % of saccharides, 35 wt % of writer with respect to the weight of main dough as shown in table I below.

In the case of including more than 5 wt % Opuntia Ficus-indica fruit powder, dough is not suitable to produce a food, since texture becomes hard and fermentation expansion is weakened to deteriorate food quality. In addition, in the case of including more than 35 wt % of water, a cohesive viscoelastic substance, which is difficult to treat, is produced through hydration, while in the case of including less water than 35 wt %, dough retains insufficient cohesiveness.

During mixing, warm water haying temperature of about 95° C. is used.

TABLE 1

| Ingredient | Content (weight %) | | |
|---|---|---|---|
| OFP | 1 | 3 | 5 |
| Saccharides | 5 | 5 | 5 |
| Water | 35 | 35 | 35 |
| Total | 41 | 43 | 45 |

(b) Stirring Step (S120)

This is a step to homogenously distribute each ingredient in the mixture, which is produced in the mixing step (S110) by appropriately mixing ingredients, by introducing the mixture in a constant-temperature water bath and stirring. Stirring is performed for about 30 minutes in a constant-temperature water bath of which inside temperature is maintained at 90° C. by using the stirrer rotating at a speed of about 1,000 rpm.

(c) Aging Step (S130)

This is a step to aging acidic dough, which is formed by the mixing step (S110) and the stirring step (S120), for a certain period of time under a condition in which appropriate temperature is maintained. To perform aging, acidic dough prepared in the above steps is introduced, in an incubator of which temperature is maintained at 60° C. for aging for about 3 hours,

As described above, since Opuntia Ficus-indica fruit powder contains a large amount of dietary fibers which make dough have high viscosity, texture becomes poor when a food is made of Opuntia Ficus-indica fruit powder and also a food producing process becomes difficult. However, the present invention can achieve desired texture and allows following food producing process to be easily performed, since a food is produced by using acidic dough having reduced viscosity by: mixing saccharides such as ot igosaccharides or sucrose with an ingredient; compounding dough in a constant-temperature water bath having high temperature (90° C.) by using warm water having high temperature (95° C.); and then introducing the mixture in an incubator which maintains 60° C. for aging so that viscosity of acidic dough is significantly reduced in a short period of time (3 hours).

(2) Liquid Starter Preparation Step (S200)

This is a step to produce liquid starter by mixing flour with acidic dough having appropriately reduced viscosity which is prepared by the above steps in a stirrer. To perform this step. acidic dough is mixed with 10 wt % of flour with respect to the weight of main dough and then the mixture is aged for 1 to 3 hours in a condition in which temperature of 28 to 30° C. and relative humidity of 75 to 80% are maintained. As a result, liquid starter is completed.

Among methods for preparing dough to produce a food, there are a straight dough method, a sponge dough method, a brew process, a continuous dough making process and so forth. Among various above methods for preparing dough, the brew process is selected and used in the present invention, wherein the brew process is that liquid starter is prepared at first and then pre-fermented, and thereafter main dough is prepared by adding rest ingredients to the liquid starter. The brew process is advantageous for mass production of a food and also advantageous for fermentation than other methods, since a particularly large amount of vitamin C. which has an antioxidative effect on a food, contained in an Opuntia Ficus-indica fruit plays a role as a bread improver which improves bread making quality by exhibiting an effect of oxidizer to dough in fermentation of liquid starter.

(3) Main Dough Preparation Step (S300)

This is a step to form main dough after achieving liquid starter through the liquid starter preparation step (S200) by adding grain powder, flour, salt, and so forth in an amount corresponding to remaining 45 to 49 wt % to liquid starter (51 to 55 wt %) in a stirrer.

In the present invention, black rice powder and brown rice powder are used as grain powders which are added to produce main dough, since these grain powders have effect on treating diabetes mellitus, as well as antioxidative elect due to the rich vitamin and mineral contents.

(4) Fermentation Step (S400)

This is a step to ferment main dough, which is prepared in the main dough preparation step (S300) as above, in a tormentor in which temperature of 26 to 28° C. and relative humidity of 75 to 80% are maintained for 30 to 40 minutes.

(5) Food Producing Step (S500)

This is a step to finally produce a food by using main dough, which is completely fermented by the fermentation step (S400) as above. The food producing step (S500) of the present invention can include a shaping step (S510) and a second fermentation step (S520) below.

(a) Shaping Step (S510)

This is a step for pre-shaping completely fermented main dough to produce bread or snack foods in a desired form.

(b) Second Fermentation Step (S520)

This is a step to re-ferment the shaped main dough which is shaped in to certain form by the shaping step (S510) in a fermentor in which temperature of 36 to 38° C. and relative humidity of 80 to 85% is maintained for 40 to 50 minutes. Through this step, a food having improved texture, volume, and flavor can be produced.

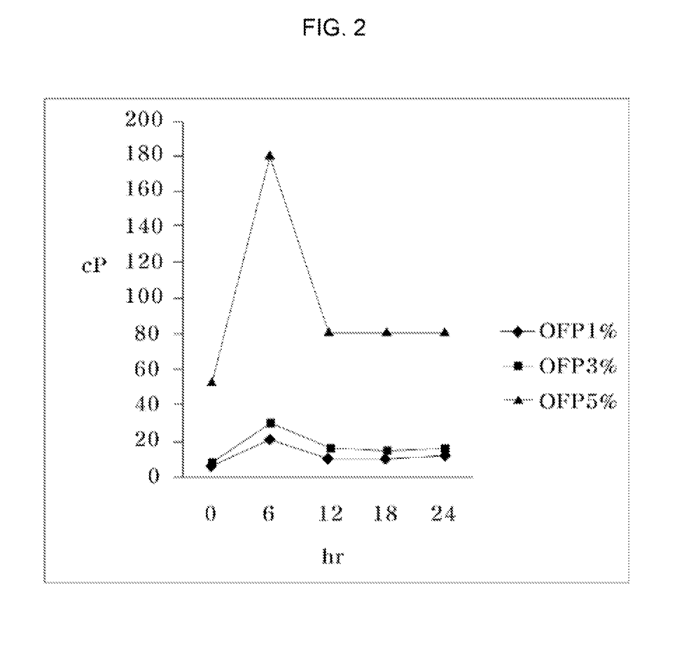

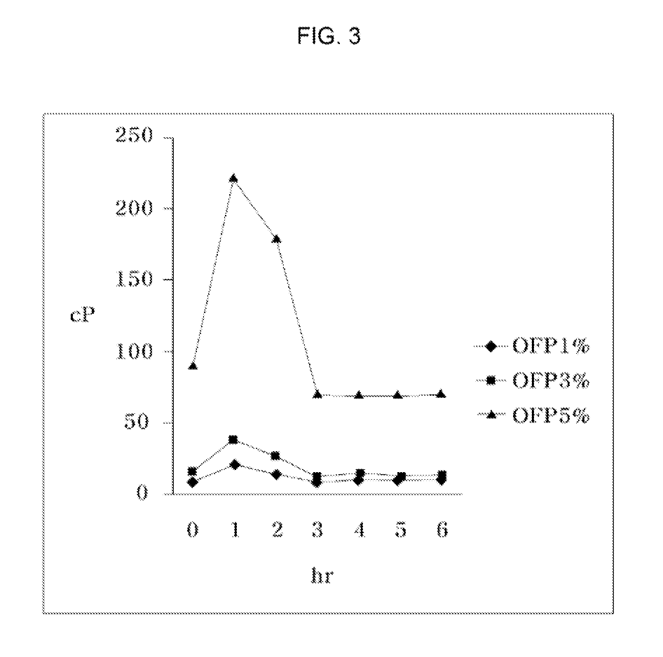

To validate changes in viscosity of the present invention described above and compare to the conventional method, the present inventor produces dough according to the process as table 2 below. Then, to observe changes in viscosity of dough, measuring was performed during 24 hours. Between 0 to 6 hours, measuring was performed at an interval of 1 hour, and between 6 to 24 hours, measuring was performed at an interval of 6 hours. As a result, as shown in table 3 and FIGS. 2 and 3 below, it can be found that time for reducing viscosity is remarkably shortened in the case of acidic dough prepared by the method of the present invention comparing to that of dough prepared by the conventional method and also an ability to reduce viscosity of dough is slightly better in the case where oligosaccharide is used as saccharides than sucrose.

TABLE 2

| | | | | | Comparative | Comparative |
|---|---|---|---|---|---|---|
| | | Example 1 | Example 2 | Example 3 | Example 1 | Example 2 |
| Ingredient | OFT | 3 | 5 | 5 | 3 | 5 |
| (weight %) | Saccharides | 5 | 5 | 5 | 5 | 5 |
| | | (oligosaccharide) | (oligosaccharide) | (sucrose) | (oligosaccharide) | (oligosaccharide) |
| | Water | 35 (95° C.) | 35 (95° C.) | 35 (95° C.) | 35 (70° C.) | 35 (70° C.) |

| | | | | | |
|---|---|---|---|---|---|
| Compounding | constant- | constant- | constant- | — | — |
| | temperature | temperature | temperature | | |
| | water bath | water bath | water bath | | |
| | (90° C.) | (90° C.) | (90° C.) | | |
| Stirring | 10,000 rpm, | 10,000 rpm, | 10,000 rpm, | 10,000 rpm, | 10,000 rpm, |
| | 30 minutes | 30 minutes | 30 minutes | 5 minutes | 5 minutes |
| Aging | 60° C. | 60° C. | 60° C. | 25° C. | 25° C. |

TABLE 3

| | | | | | Comparative | Comparative |
|---|---|---|---|---|---|---|
| | | Exam- | Exam- | Exam- | Example 1 | Example 2 |
| Hours | | ple 1 (cP) | ple 2 (cP) | ple 3 (cP) | (cP) | (cP) |
| 0 | hours | 16 | 90 | 80 | 10 | 55 |
| 1 | hours | 38 | 220 | 210 | 10 | 55 |
| 2 | hours | 27 | 180 | 200 | 10 | 60 |
| 3 | hours | 13 | 70 | 90 | 15 | 100 |
| 4 | hours | 13 | 70 | 80 | 20 | 120 |
| 5 | hours | 13 | 70 | 80 | 25 | 150 |
| 6 | hours | 13 | 70 | 80 | 30 | 180 |
| 9 | hours | 13 | 70 | 80 | 20 | 120 |
| 12 | hours | 13 | 70 | 80 | 16.5 | 80 |
| 18 | hours | 13 | 70 | 80 | 15 | 80 |
| 24 | hours | 13 | 70 | 80 | 16 | 80 |

Further, to investigate whether the method for producing a food of the present invention including the steps described above can be applied to practical food production, the present inventor produces dough according to the above steps then actually produces a food (e.g., sweet pastries) using the produced dough, which will be described below as one example.

### EXAMPLE

Firstly, as table 4 below 5 wt % of Opuntia Ficus-indica fruit powder, 5 wt % of oligosaccharide, and 35% of warm water having temperature of 95° C. with respect to the weight of main dough were respectively introduced and compounded. The mixture was stirred with a stirrer rotating at a speed of about 10,000 rpm in a constant-temperature water bath which maintains temperature of 90° C. for 30 minutes.

Thereafter, the resultant mixture was aged for 3 hours in an incubator which maintains temperature of 60° C. to produce acidic dough.

Then, acidic dough prepared by the above process was mixed with 10 wt % of flour with respect to the weight of main dough. The mixture was stirred at a first stage speed for 2 minutes, then aged for 3 hours under a condition in which temperature of 28° C. and relative humidity of 75% were maintained to complete liquid starter.

Thereafter, liquid starter was mixed with 27 wt % of flour, 5 wt % of brown rice powder, 5 wt % of black rice powder, 1 wt % of salt, 2 wt % of live-yeast, and 2 wt % of skim milk with respect to the weight of main dough and the resultant mixture was introduced into a stirrer to stir at a first stage speed for 2 minutes. Butter of 3 wt % was added to the mixture and sufficiently stirred for 4 minutes at a first stage speed and for 10 minutes at a second stage sped to produce main dough. Main dough was fermented for 40 minutes in a fermentor in which temperature of 28° C. and relative humidity of 75% were maintained, Main dough was shaped in a circular form. Then, the shaped main dough was secondly fermented for 40 minutes in a fermentor in which. temperature of 38° C. and relative humidity of 80% were maintained. The resultant dough was baked for 15 minutes in a bread machine in which temperature was maintained at 180° C. Consequently, obtained is snack bread having, a stable internal phase, homogenous bubbles, good texture as well as added flavor of Opuntia Ficus-indica fruit and slightly less volume compared to that of conventional bread in which Opuntia Ficus-indica fruit powder is not included.

TABLE 4

| Ingredient | Content (Weight %) |
|---|---|
| Flour | 37 |
| OFP | 5 |
| Oligosaccharides | 5 |
| Brown rice powder | 5 |
| Black rice powder | 5 |
| Salt | 1 |
| Live-yeast | 2 |
| Skim milk | 2 |
| Butter | 3 |
| Water | 35 |
| Total | 100 |

Further, the present inventor allows a white mouse to freely intake snack bread produced by the above method. Then, blood glucose level was observed. As a result, it can be found that blood glucose level started to decrease at 3 weeks, and thereby a tendency of significantly recovering blood glucose level is exhibited.

1. A method for producing a food using an Opuntia Ficus-indica fruit, the method comprising:
an acid dough preparation step of preparing acidic dough by using an ingredient comprising an Opuntia Ficus-indica fruit;
a liquid starter preparation step of preparing liquid starter by mixing flour with the acidic dough prepared in the acidic dough preparation step in a stirrer;
a main dough preparation step of preparing main dough by adding grain powder, flour, and salt to the liquid starter prepared in the liquid dough preparation step in the stirrer;
a fermentation step of introducing the main dough prepared in the main dough preparation step in a fermentor to ferment; and
a food producing step of producing a food by using the main dough fermented by the fermentation step,
wherein the acidic dough preparation step includes: a mixing step of mixing ingredients in the stirrer; a stirring step of introducing the mixture prepared by the mixing step in the stirrer to stir; and an aging step of introducing the acidic dough stirred in the stirring step in an incubator for a certain period of time for aging; and the ingredients mixed in the mixing step include saccharides and water.

2. The method for producing a food using an Opuntia Ficus-indica fruit of claim 1, wherein the ingredients in the mixing step are mixed at a ratio of 1 to 5 wt % of Opuntia Ficus-indica fruit powder, 5 wt % of saccharides, 35 wt % of water with respect to the weight of main dough.

3. The method for producing a food using an Opuntia Ficus-indica fruit of claim 1, wherein the stirring process in the stirring step is performed for 30 minutes in a constant-temperature water bath of which inside temperature is maintained at 90° C.

4. The method for producing a food using an Opuntia Ficus-indica fruit of claim 1, wherein the aging process of the aging step is performed for 3 hours in the incubator of which inside temperature is maintained at 60° C.

5. The method for producing a food using an Opuntia Ficus-indica fruit of claim 1, wherein the process of preparing liquid starter in the liquid starter preparation step is performed by mixing the acidic dough with 10 wt % of flour with respect to the weight of main dough and then aging the resultant for 1 to 3 hours under a condition in which temperature of 28 to 30° C. and relative humidity of 75 to 80% are maintained.
